(19) United States
(12) Patent Application Publication
(10) Pub. No.: US 2018/0290726 A1
(43) Pub. Date: Oct. 11, 2018

(54) STOPPING DEVICE, MOVING MECHANISM AND AIRCRAFT

(71) Applicant: AIRBUS (BEIJING) ENGINEERING CENTRE COMPANY LIMITED, Bejing (CN)

(72) Inventor: Yumin SUN, Beijing (CN)

(21) Appl. No.: 15/949,502

(22) Filed: Apr. 10, 2018

(30) Foreign Application Priority Data
Apr. 11, 2017 (CN) 201710233077.7

(51) Int. Cl. B64C 9/02; F16F 7/12

(52) U.S. Cl. CPC B64C 9/02; B64C 9/14; F16F 2224/0266; F16F 7/121

(57) ABSTRACT

The present application relates to a stopping device, a moving mechanism and an aircraft. The moving mechanism is connected to a stationary structure of the aircraft so as to allow the moving mechanism to move relative to the stationary structure. The stopping device includes a first stopper provided at the moving mechanism and a second stopper provided at the stationary structure, and is configured such that when a drive connection structure of the moving mechanism fails, the first stopper is adapted to abut against the second stopper to limit the moving range of the moving mechanism. At least one of the first stopper and the second stopper includes a buffer region made by modifying its meso-structure and thus has a reduced density to thereby be adapted to reduce a dynamic load generated when the first stopper collides with the second stopper.

This application claims priority to Chinese Patent Application No. 201710233077.7, filed on Apr. 11, 2017, which is incorporated by reference in its entirety herein.

### FIELD OF THE INVENTION

This application relates to a stopping device, a moving mechanism including the stopping device and an aircraft including the moving mechanism, and in particular to a stopping device which is capable of reliably reducing a dynamic load in collision in a case that a drive connection structure of the moving mechanism fails.

### BACKGROUND OF THE INVENTION

In an aircraft, such as an airplane, a variety of different moving components are provided for achieving respective functions. For example, these moving components include various moving airfoils arranged on wings, such as flaps for obtaining a larger lift and a better maneuvering capability at a low speed (the flaps may be classified as inboard flaps and outboard flaps and may also be classified as leading slats and trailing flaps, etc.), an aileron for controlling a transverse tilting attitude of an airplane, an airbrake for increasing resistance to reduce the speed of the airplane and the like.

In use, there is a probability that a moving component may fail, for example, there is a probability that a drive connection structure (for example, a transmission rod) of the moving component may fail (for example, break). Therefore, it may be considered to provide a stopping device for the moving component to limit a moving range of the moving component when the drive connection structure of the moving component fails, so as to, for example, prevent a fragile and important wing body of the moving component from colliding with a stationary structure, (for example, a framework structure of a wing) for mounting the moving component, of the aircraft and thus prevent damaging the wing body.

However, the inventor still found that there is room for improving the stopping device, for example, there is a need for improving a buffer performance of the stopping device, i.e., reducing a dynamic load factor of the stopping device.

Here, it is to be noted that, the technical contents provided in this section are intended to assist understanding of the present application by the person skilled in the art, and do not necessarily constitute the prior art.

### SUMMARY OF THE INVENTION

A general summary rather than a comprehensive presentation of full scope of the present application or all of the features of the present application is provided in this section.

One object of the present application is to provide a stopping device which can be formed simply and reliably and has an improved buffer performance.

Another object of the present application is to provide a stopping device which can facilitate reducing a dynamic load factor and thus reducing a dynamic load in collision.

Still another object of the present application is to provide a stopping device which has a buffer region with a density gradually increased in a collision direction.

Still another object of the present application is to provide a stopping device which has a stopper with reduced size and weight.

Still another object of the present application is to provide a stopping device which can achieve stopping within a small space.

Other objects of the present application are to provide a moving mechanism including the stopping device described above and an aircraft including the moving mechanism described above.

For achieving one or more of the above objects, according to an aspect of the present application, a stopping device for a moving mechanism of an aircraft is provided. The moving mechanism is connected to a stationary structure of the aircraft so as to allow the moving mechanism to move relative to the stationary structure, the stopping device includes a first stopper provided at the moving mechanism and a second stopper provided at the stationary structure, the stopping device is configured such that, when a drive connection structure of the moving mechanism is normal, the first stopper does not abut against the second stopper, and when the drive connection structure fails, the first stopper is adapted to abut against the second stopper so as to limit a moving range of the moving mechanism. At least one of the first stopper and the second stopper includes a buffer region which is made by modifying its meso-structure and thus has a reduced density to thereby be adapted to reduce a dynamic load generated when the first stopper collides with the second stopper.

In the above stopping device, the buffer region has a meso-structure in a three-dimensional lattice form.

In the above stopping device, the buffer region has a meso-structure in a three-dimensional lattice form achieved by a three-dimensional printing process.

In the above stopping device, the buffer region is configured to include a plurality of layers having different meso-structures and arranged from a collision side to a base side, and the closer a layer is to the collision side, the smaller a cross sectional dimension of a connecting rod of a lattice cell in the layer is.

In the above stopping device, each of the layers includes a first sub-layer and a second sub-layer formed by arranging a plurality of truncated regular or oblique hexagonal pyramid lattice cells side by side, such that an imaginary small top face of a truncated regular or oblique hexagonal pyramid lattice cell of the first sub-layer is connected with an imaginary small top face of a corresponding truncated regular or oblique hexagonal pyramid lattice cell of the second sub-layer or that an imaginary large top face of a truncated regular or oblique hexagonal pyramid lattice cell of the first sub-layer is connected with an imaginary large top face of a corresponding truncated regular or oblique hexagonal pyramid lattice cell of the second sub-layer.

In the above stopping device, the three-dimensional lattice is formed by stacking polyhedral lattice cells which are of multiple kinds or of one single kind and which are identically sized or differently sized.

In the above stopping device, the polyhedral lattice cell includes a truncated regular or oblique hexagonal pyramid, a regular or oblique hexagonal prism, a regular or oblique triangular prism and a regular or oblique hexahedron.

In the above stopping device, the buffer region has a meso-structure in a three-dimensional porous form.

In the above stopping device, the buffer region has a meso-structure in a three-dimensional porous form achieved by a three-dimensional printing process or a metal powder or particle sintering process.

In the above stopping device, the buffer region is configured to include a plurality of layers having different meso-structures and arranged from a collision side to a base side, and the closer a layer is to the collision side, the greater the porosity of the layer is.

In the above stopping device, the buffer region is configured such that the density of the buffer region is increased step by step or substantially continuously from a collision side to a base side.

In the above stopping device, the buffer region is configured to include a plurality of layers having different meso-structures and arranged from a collision side to a base side, such that, the closer a layer is to the collision side, the smaller the density of the layer is.

In the above stopping device, the at least one of the first stopper and the second stopper further includes a stiff region having a greater density, and the stiff region and the buffer region are made of the same material.

In the above stopping device, the buffer region is arranged at a collision side part of the at least one of the first stopper and the second stopper.

In the above stopping device, the stiff region includes a stiff base located at a base side part of the at least one of the first stopper and the second stopper and a stiff wall extending to the collision side part so as to surround the buffer region.

For achieving one or more of the above objects, according to another aspect of the present application, a moving mechanism for an aircraft is provided. The moving mechanism includes the stopping device described above.

In the above moving mechanism, the moving mechanism is a flap assembly, and the flap assembly includes a flap body and a movable support structure configured to support the flap body.

In the above moving mechanism, the stationary structure includes a mounting protrusion of a wing rib of the aircraft, and the first stopper is provided at the movable support structure and the second stopper is provided at the mounting protrusion.

In the above moving mechanism, the second stopper is directly mounted to the mounting protrusion, or the second stopper is mounted to a mounting bracket bridging two adjacent mounting protrusions so as to be indirectly mounted to the mounting protrusions.

For achieving one or more of the above objects, according to another aspect of the present application, an aircraft is provided. The aircraft includes the moving mechanism described above.

According to the present application, the buffer region is made in the stopper of the stopping device by modifying the meso-structure of the stopper, thus, a stopping device having an improved buffer performance can be simply and reliably formed, and thereby, the dynamic load factor of the stopping device can be advantageously reduced, and further the dynamic load of the stopping device in collision can be reduced. Particularly, by gradually increasing the density of the buffer region in the collision direction (the density is in ladder distribution), the dynamic load factor of the stopping device can be effectively reduced. In addition, making the buffer region in the stopper of the stopping device by modifying the meso-structure of the stopper can reduce the dimension and the weight of the stopper of the stopping device. In addition, since the buffer region having a density ladder (stepwise) distribution is made in the stopper of the stopping device by modifying the meso-structure of the stopper and the stopping device is further provided with a stiff region, the moving stroke (rotating angle) of the moving mechanism when opposite collision parts collide can be reduced while an improved buffer performance is provided, thereby achieving the so called stopping within a small space.

### BRIEF DESCRIPTION OF THE DRAWINGS

Features and advantages of one or more embodiments of the present application can be understood more readily with reference to the following description in conjunction with the drawings in which:

FIG. 1 is a top view showing an aircraft according to the present application;

FIG. 2 is a schematic view showing a flap assembly and an associated stationary structure according to the present application;

FIG. 3 is a schematic view showing a stopping device according to the present application;

FIG. 4 is a schematic view showing a variation of the stopping device according to the present application;

FIGS. 5 and 6 are respectively schematic views showing details of a second stopper and a first stopper according to the present application;

FIG. 7 is a schematic view showing another variation of the stopping device according to the present application;

FIG. 8 is a cross sectional view showing the stopper according to the present application taken along a collision direction;

FIG. 9 is a perspective view showing multiple lattice cells, arranged along the collision direction, of a first example of the lattice structure according to the present application;

FIG. 10 is a top view showing the lattice structure constituted by multiple lattice cells shown in FIG. 9;

FIG. 11 is a top view showing one lattice cell according of a first example of the lattice structure according to the present application;

FIGS. 12a and 12b are respectively cross sectional views showing a connecting rod of the lattice cell according to the present application taken along line 12-12 shown in FIG. 11;

FIGS. 13 and 14 are respectively a perspective view and a top view showing a second example of the lattice structure according to the present application;

FIGS. 15 and 16 are respectively a perspective view and a top view showing a third example of the lattice structure according to the present application;

FIGS. 17 and 18 are respectively a perspective view and a top view showing a fourth example of the lattice structure according to the present application; and

FIG. 19 is a cross sectional view showing a stopper according to an alternative embodiment of the present application taken along the collision direction.

### DETAILED DESCRIPTION

The present application is described in detail hereinafter with reference to the accompanying drawings and by means of the exemplary embodiment. The following detailed description of the present application is only for the purpose of illustration rather than limitation to the present application and the applications or usages thereof.

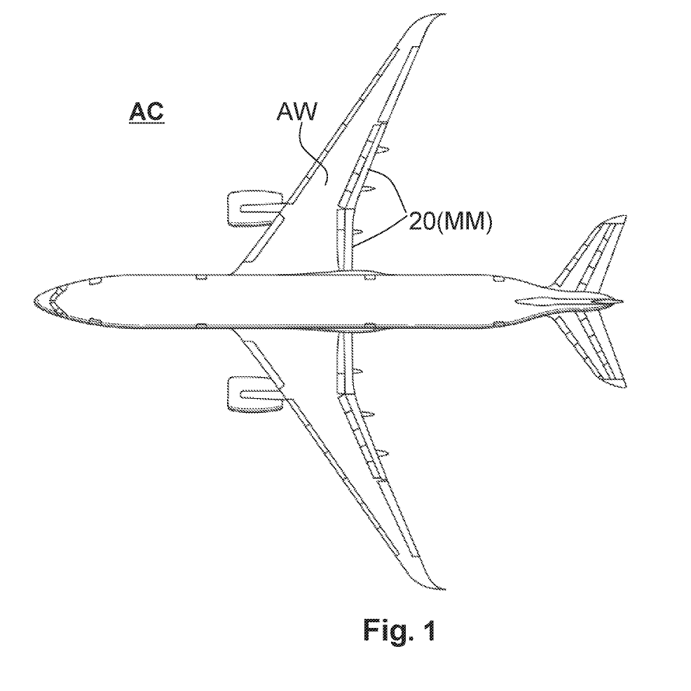

Referring to FIG. 1 (FIG. 1 is a top view showing an aircraft according to the present application), the aircraft AC according to the present application may include a moving mechanism MM. As an example, the moving mechanism MM may be a flap assembly 20, particularly a trailing flap arranged at a trailing edge of a wing AW. Here, it should be appreciated that, the moving mechanism MM may also be an aileron assembly, a rudder, an elevator, an airbrake and the like.

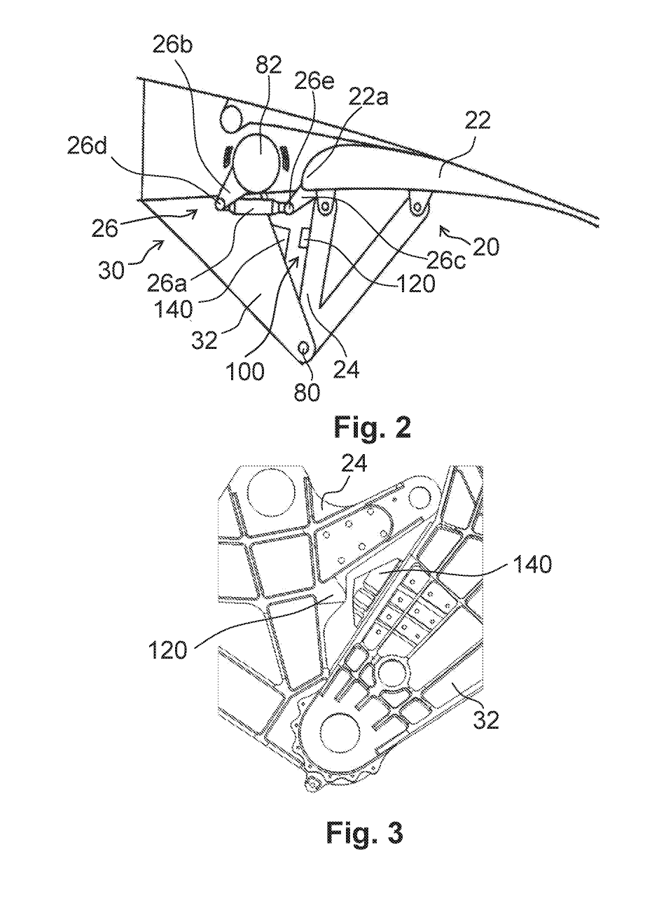

Referring to FIG. 2 (FIG. 2 is a schematic view showing a flap assembly and an associated stationary structure according to the present application), the flap assembly 20 may include a flap body 22 and a movable support structure (moving lever) 24 configured to support the flap body 22. The flap body 22 may be fixedly mounted to the movable support structure 24 so as to move integrally with the movable support structure 24.

The flap assembly 20 may be connected to a stationary structure 30 of the aircraft AC so as to allow the flap assembly 20 to move relative to the stationary structure 30. Particularly, the movable support structure 24 of the flap assembly 20 may be connected to the stationary structure 30 via a pivot shaft 80 so as to allow the flap assembly 20 to pivot relative to the stationary structure 30. Here, the stationary structure 30 may include a mounting protrusion 32 of a wing rib (i.e., an extension of the wing rib) of the aircraft AC. In addition, the flap assembly 20 may include a drive connection structure 26, and the drive connection structure 26 may include a transmission rod 26a, an actuator rod 26b of an actuator 82 and a flap rod 26c. One end of the transmission rod 26a may be pivotably connected to the actuator rod 26b via a pivot shaft 26d, and the other end of the transmission rod 26a may be pivotably connected to the flap rod 26c via a pivot shaft 26e. Thereby, when the actuator 82 rotates, the drive connection structure 26 drives the flap assembly 20 to rotate about the pivot shaft 80. When the flap assembly 20 rotates clockwise as shown in FIG. 2, the flap assembly 20 may extend outwards to be in an extended position, and when the flap assembly 20 rotates counterclockwise as shown in FIG. 2, the flap assembly 20 may be retracted inwards to be in a retracted position. In a case that the drive connection structure 26 (the transmission rod 26a, the actuator rod 26b, the flap rod 26c, the pivot shaft 26d, and/or the pivot shaft 26e) fails (for example, breaks), if no stopping device is provided, the flap assembly 20 will move freely (its moving range is not limited), thus the flap assembly 20 will move inwards excessively. Therefore, a leading end 22a of the flap body 22 may be caused to collide with a corresponding portion (trailing edge) of the stationary structure 30, thereby damaging the flap body 22 and/or a corresponding portion of the stationary structure 30.

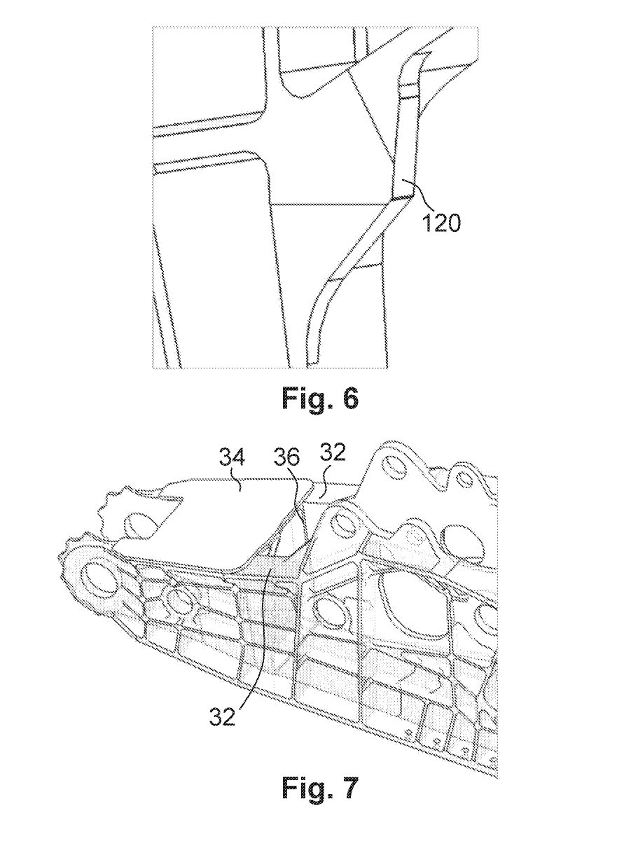

According to the present application, a stopping device 100 for the flap assembly 20 of the aircraft AC is provided. Referring also to FIGS. 3, 5, and 6 (FIG. 3 is a schematic view showing a stopping device according to the present application, and FIGS. 5 and 6 are respectively schematic views showing details of a second stopper and a first stopper according to the present application), the stopping device 100 may include a first stopper 120 provided at the flap assembly 20 and a second stopper 140 provided at the stationary structure 30. The second stopper 140 may include a collision surface 140a (see FIG. 5) configured to abut against the first stopper 120. Particularly, the first stopper 120 may be provided at the movable supporting structure 24 of the flap assembly 20, and the second stopper 140 may be provided at the mounting protrusion 32 of the stationary structure 30. With the first stopper 120 being provided at the movable support structure 24, it may avoid the first stopper 120 from being provided at the flap body 22 and thus affecting the aerodynamic performance of the flap assembly 20.

The stopping device 100 may be configured such that, when the drive connection structure 26 of the flap assembly 20 is normal, the first stopper 120 does not abut against the second stopper 140 (namely, they are not in contact with each other or are simply in contact with each other without pressing each other or interfering with each other), and when the drive connection structure 26 fails, the first stopper 120 is capable of abutting against the second stopper 140 so as to limit the moving range of the flap assembly 20 (particularly, restricting the excessive inward movement of the flap assembly 20, namely, restricting the flap assembly 20 from excessively rotating counterclockwise as shown in FIG. 2).

The second stopper 140 may be simply mounted right on the mounting protrusion 32 (completely directly or via a necessary gasket), this way can be referred to as a direct mounting way. In this way, the mounting structure of the stopping device can be simplified, thereby reducing the interference of the stopping device to a main body structure of the flap assembly and also facilitating weight reduction of the flap assembly. In addition, this mounting way also facilitates replacement of the second stopper 140.

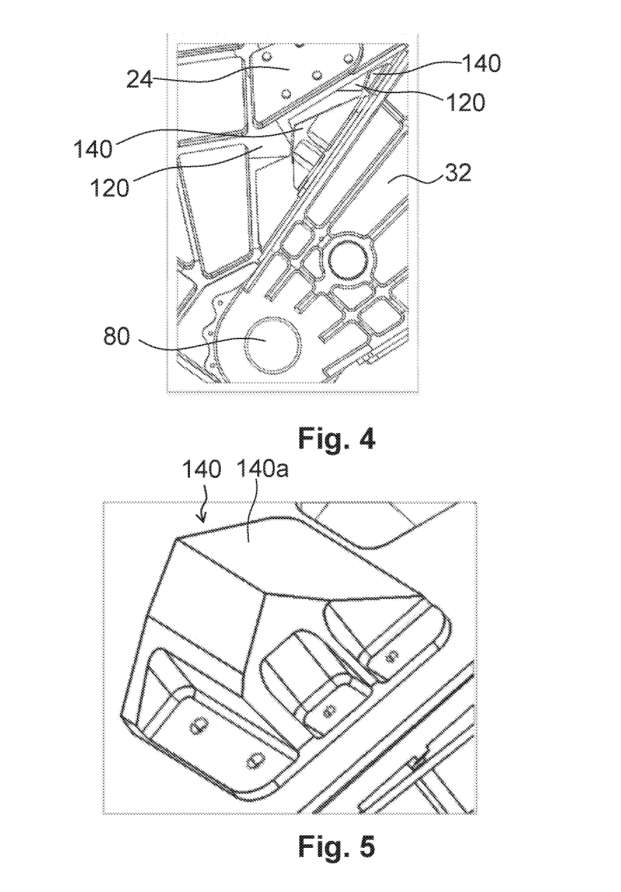

Referring to FIG. 4 (FIG. 4 is a schematic view showing a variation of the stopping device according to the present application), in a variation of the stopping device 100, two pairs of stoppers may be provided along a longitudinal direction of the mounting protrusion 32. In this way, in a case that one pair of stoppers fail, the other pair of stoppers can provide the stopping function, or the two pairs of stoppers may provide the stopping function simultaneously, thereby more reliably providing the stopping effect and having a sufficient safety measure when a failure occurs.

Referring to FIG. 7 (FIG. 7 is a schematic view showing another variation of the stopping device according to the present application), in another variation of the stopping device 100, instead of the above direct mounting way, the second stopper 140 may be mounted to a mounting bracket 34 bridging two adjacent mounting protrusions 32 so as to be indirectly mounted to the mounting protrusions 32 (this way may be referred to as an indirect mounting way). In this way, the stopping length in the wingspan direction may be increased, thereby providing a reliable stopping effect. In the variation, it may further provide a supporting frame (for example, in a substantially rectangular shape) 36 located between two adjacent mounting protrusions 32 and configured to further support the mounting bracket 34. In this way, the stopper 140 may be more reliably supported and also the load transmission may be facilitated.

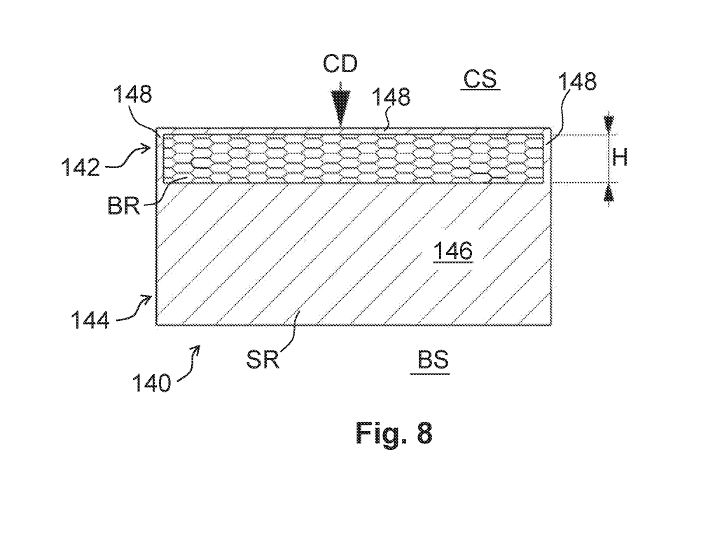

According to the present application, referring to FIG. 8 (FIG. 8 is a cross sectional view showing the stopper according to the present application taken along a collision direction), at least one of the first stopper 120 and the second stopper 140 may include a buffer region BR (a region having a meso-structure specially designed) made by modifying its meso-structure (a structure between a macrostructure and a microstructure). Thereby, the buffer region BR may have a reduced density, correspondingly, the buffer region BR may have an increased flexibility and a reduced stiffness, to thereby be adapted to reduce the dynamic load (or in other words, be adapted to improve the buffer performance of the stopping device, i.e., to reduce a dynamic load factor of the stopping device) when the first stopper 120 collides with the second stopper 140.

In an example, the second stopper 140 may include a buffer region BR and may be a separate member mounted to the mounting protrusions 32, and the first stopper 120 may not include a buffer region BR and may be a stopper integrally formed with the movable support structure 24.

The buffer region BR may have a meso-structure in a three-dimensional lattice form. In an example, the buffer region BR may have a meso-structure in a three-dimensional lattice form achieved by a three-dimensional printing process.

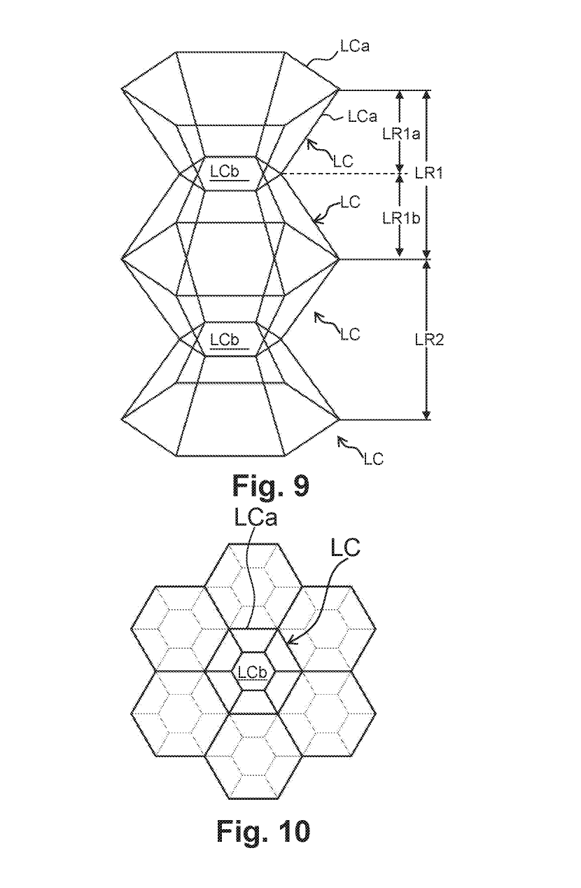

The buffer region BR may be configured to include multiple layers LR1, LR2 (see FIG. 9) having different meso-structures and arranged from a collision side CS to a base side BS (i.e., in a collision direction CD). Each layer includes multiple lattice cells, and each lattice cell includes multiple apexes and connecting rods or edges connecting respective apexes, reference may be made to the following description for details. The buffer region BR may be configured such that the closer a layer is to the collision side CS, the smaller the cross sectional dimension of the connecting rod (edge) of the lattice cell in that layer is. Thereby, the closer a layer is to the collision side CS, the smaller its appearance density is, the greater its flexibility is, and the smaller its stiffness is. Similarly, the buffer region BR may be configured such that the farther a layer is away from the collision side CS, the larger the cross sectional dimension of the connecting rod (edge) of the lattice cell in that layer is. Thereby, the farther a layer is away from the collision side CS, the greater its appearance density is, the smaller its flexibility is, and the greater its stiffness is.

The three-dimensional lattice may be formed by stacking multiple kinds or one single kind of polyhedral lattice cells having the same dimension or different dimensions. Here, it is to be noted that, in the three-dimensional lattice structure, the polyhedron of the lattice cell is an imaginary polyhedron (particularly, the faces of the lattice cell are imaginary faces, i.e., are actually empty), and a certain edge or face may be shared by two adjacent lattice cells.

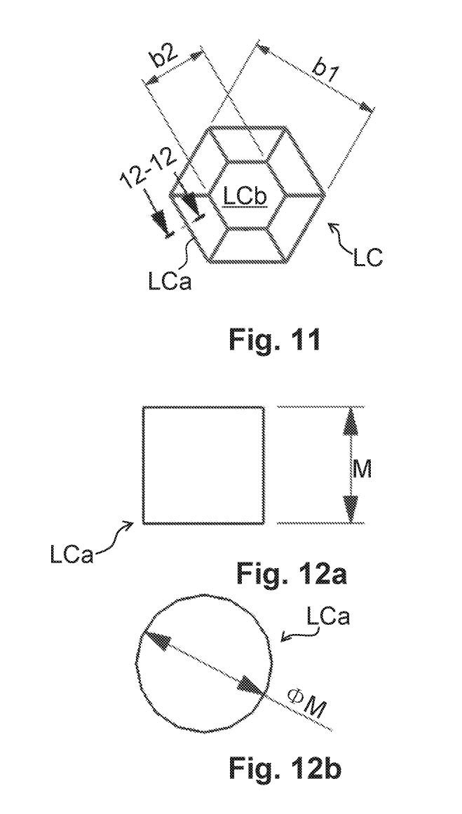

Referring to FIGS. 9, 10, 11, 12a and 12b (FIG. 9 is a perspective view showing multiple lattice cells, arranged along the collision direction, of a first example of the lattice structure according to the present application, FIG. 10 is a top view showing the lattice structure constituted by multiple lattice cells shown in FIG. 9, FIG. 11 is a top view showing one lattice cell according of a first example of the lattice structure according to the present application, and FIGS. 12a and 12b are respectively cross sectional views showing a connecting rod of the lattice cell according to the present application taken along line 12-12 shown in FIG. 11), in a first example of the lattice structure, the polyhedral lattice cell LC may include a truncated regular hexagonal pyramid. Particularly, each layer may include a first sub-layer LR1a and a second sub-layer LR1b formed by arranging multiple truncated regular hexagonal pyramid lattice cells side by side, such that an imaginary small top face LCb of a truncated regular hexagonal pyramid lattice cell of the first sub-layer LR1a is connected with an imaginary small top face LCb of a corresponding truncated regular hexagonal pyramid lattice cell of the second sub-layer LR1b (or in other words, the two truncated regular hexagonal pyramid lattice cells share one small top face LCb). By forming the lattice structure with the truncated regular hexagonal pyramid lattice cells in this way, a relatively stable meso-structure can be provided for the layers of the buffer region BR, and also the layers are allowed to easily have different expected densities one from another. In an example, a cross sectional dimension of a connecting rod of a lattice cell of the first layer LR1 of the lattice structure may be smaller than a cross sectional dimension of a connecting rod of a lattice cell of the second layer LR2 of the lattice structure. Or, a cross sectional dimension of a connecting rod of a lattice cell of the first sub-layer LR1a of the lattice structure may be smaller than a cross sectional dimension of a connecting rod of a lattice cell of the second sub-layer LR1b.

In some examples, as shown in FIG. 12a, the cross section of the connecting rod (edge) LCa may be in a square shape or a substantially square shape, and in this case, the cross sectional dimension of the connecting rod LCa may be indicated by a side length M. In other examples, as shown in FIG. 12b, the cross section of the connecting rod LCa may be in a circular shape or a substantially circular shape, and in this case, the cross sectional dimension of the connecting rod LCa may be indicated by a diameter ØM. However, it may be appreciated that, the connecting rod LCa may also have other appropriate cross sectional shapes (for example, a triangular shape).

In an example, the buffer region BR may have a height H of 10 mm The buffer region BR may be divided into five layers, and each of the layers may have a height of 2 mm and each of the layers includes two truncated regular hexagonal pyramid lattice cells in the collision direction CD (a height direction). For one truncated regular hexagonal pyramid lattice cell, a dimension b1 of a large top face of the truncated regular hexagonal pyramid may be 2 mm (equal to the height of each layer), and a dimension b2 of the small top face LCb of the truncated regular hexagonal pyramid may be 1 mm. Among the five layers, a cross sectional dimension M1 of the connecting rod LCa in the first layer closest to the collision side CS may be 0.2 mm, and a cross sectional dimension M2 of the connecting rod LCa in the second layer secondly closer to the collision side CS may be 0.3 mm, a cross sectional dimension M3 of the connecting rod LCa in the third layer thirdly closer to the collision side CS may be 0.4 mm, a cross sectional dimension M4 of the connecting rod LCa in the fourth layer fourthly closer to the collision side CS may be 0.5 mm, and a cross sectional dimension M5 of the connecting rod LCa in the fifth layer farthest away from the collision side CS may be 0.6 mm Here, it should be appreciated that, the dimension of the buffer region and the dimension of the lattice cells constituting the buffer region may also be other appropriate dimension values.

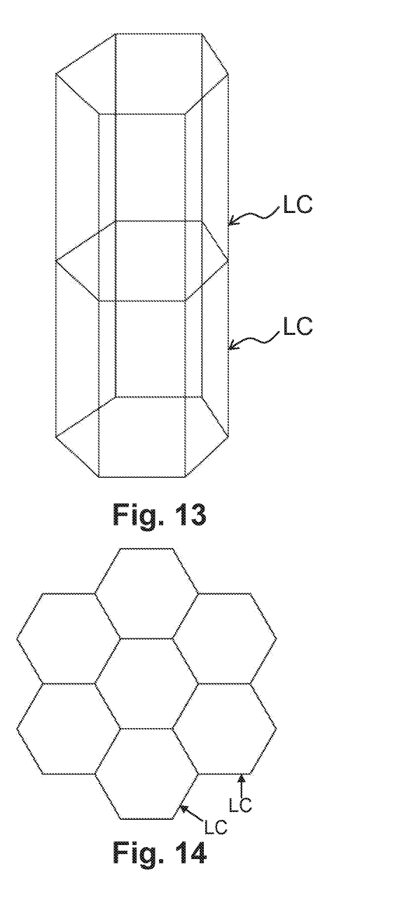

Referring to FIGS. 13 and 14 (FIGS. 13 and 14 are respectively a perspective view and a top view showing a second example of the lattice structure according to the present application), in a second example of the lattice structure, the polyhedral lattice cell LC may include a regular hexagonal prism.

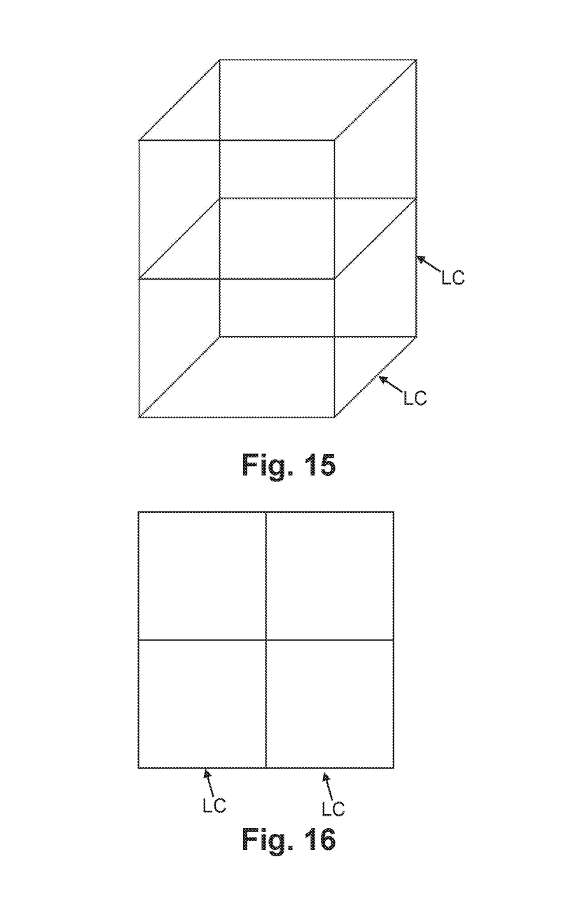

Referring to FIGS. 15 and 16 (FIGS. 15 and 16 are respectively a perspective view and a top view showing a third example of the lattice structure according to the present application), in a third example of the lattice structure, the polyhedral lattice cell LC may include a regular hexahedron.

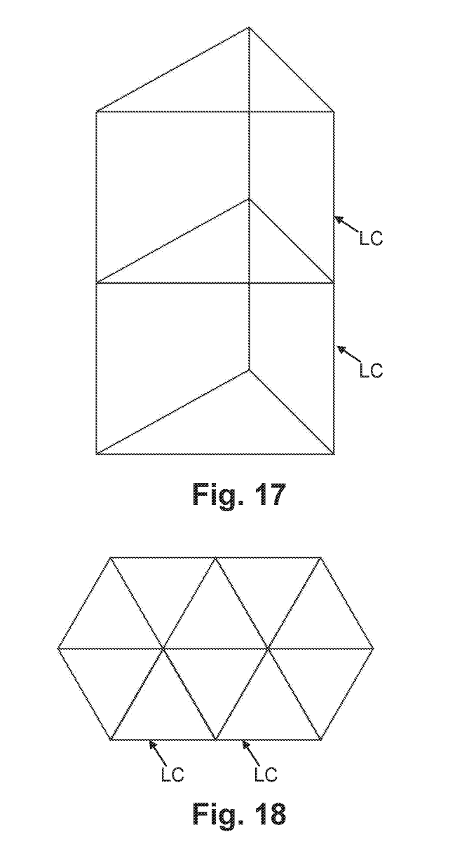

Referring to FIGS. 17 and 18 (FIGS. 17 and 18 are respectively a perspective view and a top view showing a fourth example of the lattice structure according to the present application), in a fourth example of the lattice structure, the polyhedral lattice cell LC may include a regular triangular prism.

In the second to fourth examples of the lattice structure, the lattice cells can achieve the so called tessellation in a two-dimensional plane and a three dimensional space, thereby allowing the meso-structure to be relatively regular so as to simplify the forming of the three-dimensional lattice structure.

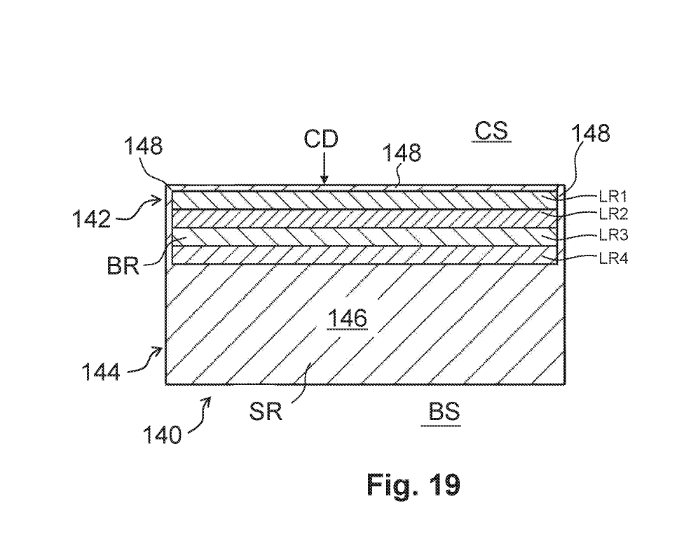

Referring to FIG. 19 (FIG. 19 is a cross sectional view showing a stopper according to an alternative embodiment of the present application taken along the collision direction), in an alternative embodiment, the buffer region BR may have a meso-structure in a three-dimensional porous form. In an example, the buffer region BR may have a meso-structure in a three-dimensional porous form achieved by a three-dimensional printing process or a metal powder or particle sintering process.

As shown in FIG. 19, the buffer region BR may be configured to include multiple layers LR1, LR2, LR3, LR4 having different meso-structures and arranged from the collision side CS to the base side BS (i.e., in the collision direction CD). The buffer region BR may be configured such that the closer a layer is to the collision side CS, the greater the porosity of that layer is (that layer is looser and more porous). Thereby, the closer a layer is to the collision side CS, the smaller the density of that layer is, the greater the flexibility of that layer is and the smaller the stiffness of that layer is.

According to the present application, by the layering way described above, the buffer region BR may be configured to allow its density to be increased step by step from the collision side CS to the base side BS (i.e., in the collision direction CD). Alternatively, the buffer region BR may be configured to allow its density to be substantially continuously increased from the collision side CS to the base side BS (i.e., in the collision direction CD).

Referring to FIGS. 8 and 19, according to the present application, the second stopper 140 may further include a stiff region SR having a greater density (a normal region substantially solid with an unchanged density). The stiff region SR and the buffer region BR may be made of the same material. In this way, by modifying the meso-structure of a part of the stopper, it allows the stiff region and the buffer region to have different densities with a single material. Therefore, it can avoid the complexity of the manufacturing process caused by using multiple kinds of materials while improving the buffer performance of the stopping device.

The buffer region BR may be arranged at a collision side part 142 of the second stopper 140. The stiff region SR may include a stiff base 146 located at a base side part 144 of the second stopper 140 and a stiff wall 148 extending to the collision side part 142 so as to surround the buffer region BR. By arranging the buffer region BR at the collision side part 142, it may facilitate improvement of the buffer performance of the stopping device. In addition, by providing the thin stiff wall 148 surrounding the buffer region BR, it may avoid the material particles of the buffer region from separating and scattering into other parts of the flap assembly especially after a collision occurs while substantially not compromising the buffer performance.

The material making the second stopper 140 and/or the first stopper 120 may be aluminum alloy.

In summary, according to the present application, the buffer region is made in the stopper of the stopping device by modifying the meso-structure of the stopper, thus, a stopping device having an improved buffer performance can be simply and reliably formed, and thereby, the dynamic load factor of the stopping device can be advantageously reduced, and further the dynamic load of the stopping device in collision can be reduced. Particularly, by gradually increasing the density of the buffer region in the collision direction (the density is in ladder distribution), the dynamic load factor of the stopping device can be effectively reduced. In addition, making the buffer region in the stopper of the stopping device by modifying the meso-structure of the stopper can reduce the dimension and the weight of the stopper of the stopping device. In addition, since the buffer region having a density ladder (stepwise) distribution is made in the stopper of the stopping device by modifying the meso-structure of the stopper and the stopping device is further provided with a stiff region, the moving stroke (rotating angle) of the moving mechanism when opposing collision parts collide can be reduced while an improved buffer performance is provided, thereby achieving the so called stopping within a small space.

In a certain experiment, by providing the buffer region in the stopper formed by modifying the meso-structure of the stopper, the dynamic load factor may be reduced from about 1.2 to 1.7 by about 30%.

While the present application has been described with reference to the exemplary embodiment, it should be understood that the present application is not limited to the specific embodiments/examples described and illustrated in detail herein. The person skilled in the art can make various variants to the exemplary embodiment without departing from the scope defined by the claims.

1. A stopping device for a moving mechanism of an aircraft, the moving mechanism being connected to a stationary structure of the aircraft so as to allow the moving mechanism to move relative to the stationary structure, the stopping device comprising a first stopper provided at the moving mechanism and a second stopper provided at the stationary structure, the stopping device being configured such that, when a drive connection structure of the moving mechanism is normal, the first stopper does not abut against the second stopper, and when the drive connection structure fails, the first stopper is adapted to abut against the second stopper so as to limit a moving range of the moving mechanism,
wherein, at least one of the first stopper and the second stopper comprises a buffer region which is made by modifying its meso-structure and thus has a reduced density to thereby be adapted to reduce a dynamic load generated when the first stopper collides with the second stopper.

2. The stopping device according to claim 1, wherein the buffer region has a meso-structure in a three-dimensional lattice form.

3. The stopping device according to claim 2, wherein the buffer region has a meso-structure in a three-dimensional lattice form achieved by a three-dimensional printing process.

4. The stopping device according to claim 2, wherein:
the buffer region is configured to comprise a plurality of layers having different meso-structures and arranged from a collision side to a base side, and
the closer a layer is to the collision side, the smaller a cross sectional dimension of a connecting rod of a lattice cell in the layer is.

5. The stopping device according to claim 4, wherein each of the layers comprises a first sub-layer and a second sub-layer formed by arranging a plurality of truncated regular or oblique hexagonal pyramid lattice cells side by side, such that an imaginary small top face of a truncated regular or oblique hexagonal pyramid lattice cell of the first sub-layer is connected with an imaginary small top face of a corresponding truncated regular or oblique hexagonal pyramid lattice cell of the second sub-layer or that an imaginary large top face of a truncated regular or oblique hexagonal pyramid lattice cell of the first sub-layer is connected with an imaginary large top face of a corresponding truncated regular or oblique hexagonal pyramid lattice cell of the second sub-layer.

6. The stopping device according to claim 2, wherein the three-dimensional lattice is formed by stacking polyhedral lattice cells which are of multiple kinds or of one single kind and which are identically sized or differently sized.

7. The stopping device according to claim 6, wherein the polyhedral lattice cell comprises a truncated regular or oblique hexagonal pyramid, a regular or oblique hexagonal prism, a regular or oblique triangular prism and a regular or oblique hexahedron.

8. The stopping device according to claim 1, wherein the buffer region has a meso-structure in a three-dimensional porous form.

9. The stopping device according to claim 8, wherein the buffer region has a meso-structure in a three-dimensional porous form achieved by a three-dimensional printing process or a metal powder or particle sintering process.

10. The stopping device according to claim 8, wherein:
the buffer region is configured to comprise a plurality of layers having different meso-structures and arranged from a collision side to a base side, and
the closer a layer is to the collision side, the greater the porosity of the layer is.

11. The stopping device according to claim 1, wherein the buffer region is configured such that the density of the buffer region is increased step by step or substantially continuously from a collision side to a base side.

12. The stopping device according to claim 1, wherein the buffer region is configured to comprise a plurality of layers having different meso-structures and arranged from a collision side to a base side, such that, the closer a layer is to the collision side, the smaller the density of the layer is.

13. The stopping device according to claim 1, wherein the at least one of the first stopper and the second stopper further comprises a stiff region having a greater density, and the stiff region and the buffer region are made of the same material.

14. The stopping device according to claim 13, wherein the buffer region is arranged at a collision side part of the at least one of the first stopper and the second stopper.

15. The stopping device according to claim 14, wherein the stiff region comprises a stiff base located at a base side part of the at least one of the first stopper and the second stopper and a stiff wall extending to the collision side part so as to surround the buffer region.

16. A moving mechanism for an aircraft, wherein the moving mechanism comprises the stopping device according to claim 1.

17. The moving mechanism according to claim 16, wherein the moving mechanism is a flap assembly, and the flap assembly comprises a flap body and a movable support structure configured to support the flap body.

18. The moving mechanism according to claim 17, wherein the stationary structure comprises a mounting protrusion of a wing rib of the aircraft, and the first stopper is provided at the movable support structure and the second stopper is provided at the mounting protrusion.

19. The moving mechanism according to claim 18, wherein the second stopper is directly mounted to the mounting protrusion, or the second stopper is mounted to a mounting bracket bridging two adjacent mounting protrusions so as to be indirectly mounted to the mounting protrusions.

20. An aircraft, wherein the aircraft comprises the moving mechanism according to claim 16.
